(19) United States
(12) Patent Application Publication
(10) Pub. No.: US 2011/0089032 A1
(43) Pub. Date: Apr. 21, 2011

(54) GAS SENSOR ELEMENT AND ITS MANUFACTURING METHOD, AND GAS SENSOR EMPLOYING THE GAS SENSOR ELEMENT

(75) Inventors: Takeshi YOSHII, Kariya-shi (JP); Yasufumi Suzuki, Kariya-shi (JP); Hirokatsu Imagawa, Kariya-shi (JP)

(73) Assignee: DENSO CORPORATION, Kariya-city (JP)

(21) Appl. No.: 12/908,149

(22) Filed: Oct. 20, 2010

(30) Foreign Application Priority Data
Oct. 20, 2009 (JP) 2009-241552

(51) Int. Cl. G01N 27/30; B05D 5/00

(52) U.S. Cl. 204/429; 427/191

(57) ABSTRACT

A gas sensor element is disclosed which includes a solid electrolyte body, a measurement electrode, a reference electrode, a porous diffusion-resistant layer, a catalyst layer, and a plurality of protective layers. The catalyst layer is provided on an outer surface of the porous diffusion-resistant layer through which a measurement gas is introduced to the measurement electrode. The catalyst layer is comprised of a noble metal catalyst and catalyst-supporting particles. The protective layers are provided in layers on the catalyst layer and comprised of oxide particles. The average particle diameter of the catalyst-supporting particles of the catalyst layer is less than or equal to the average particle diameter of the oxide particles of the one of the protective layers which adjoins the catalyst layer. The further the protective layers are from the catalyst layer, the larger the average particle diameters of the oxide particles of the protective layers are.

### CROSS-REFERENCE TO RELATED APPLICATION

This application is based on and claims priority from Japanese Patent Application No. 2009-241552, filed on Oct. 20, 2009, the content of which is hereby incorporated by reference in its entirety into this application.

### BACKGROUND OF THE INVENTION

1. Technical Field of the Invention

The present invention relates to a gas sensor element for sensing the concentration of a specific component in a gas to be measured (to be simply referred to as a measurement gas hereinafter), a method of manufacturing the gas sensor element, and a gas sensor that employs the gas sensor element.

2. Description of the Related Art

In recent years, from the viewpoint of global environmental protection, the availability of gasoline direct-injection engines and alternative fuel engines, such as CNG (Compressed Natural gas) engines, has been investigated. Accordingly, gas sensors for use in combustion control of the gasoline direct-injection engines and alternative fuel engines have become a focus of attention.

As gas sensor elements to be incorporated in those gas sensors, there are known ones which include: a solid electrolyte body having oxygen ion conductivity and an opposite pair of first and second surfaces; a measurement electrode provided on the first surface of the solid electrolyte body so as to be exposed to a measurement gas; a reference electrode provided on the second surface of the solid electrolyte body so as to be exposed to a reference gas; and a porous diffusion-resistant layer through which the measurement gas is introduced to the measurement electrode.

However, the known gas sensor elements have the following problems when the measurement gas is exhaust gas from an internal combustion engine.

First, since hydrogen (H2) has a smaller molecular weight than oxygen (O2), the flowing speed of hydrogen contained in the exhaust gas through the porous diffusion-resistant layer is higher than that of oxygen contained in the same. Consequently, the hydrogen reaches the measurement electrode earlier than the oxygen, so that the partial pressure of oxygen at the measurement electrode becomes lower than the actual partial pressure of oxygen in the exhaust gas. As a result, the output (e.g., the output current or the output voltage) of the gas sensor element is deviated from the correct value that represents the actual concentration of oxygen in the exhaust gas.

In particular, in the case of the engine being a gasoline direct-injection engine, during its operation (including starting operation), the engine tends to generate more hydrogen than a conventional gasoline engine due to the difference in combustion mechanism therebetween. Moreover, in the case of the engine being a CNG engine, during its operation, the engine also tends to generate more hydrogen than a conventional gasoline engine due to the difference in composition between CNG and gasoline. Therefore, in both the cases, the output deviation of the gas sensor element due to the hydrogen contained in the exhaust gas may be significant.

Secondly, the exhaust gas from an internal combustion engine may contain poisoning substances which include P, Ca, Zn, and Si from engine oil and K, Na, and Pb from gasoline additives. Consequently, the porous diffusion-resistant layer may be clogged by glassy matter that is comprised of compounds of the substances from the engine oil and gasoline additives, thereby lowering the output of the gas sensor element. Moreover, particulate matter, which includes Si and Pb, may pass through the porous diffusion-resistant layer to reach and poison the measurement electrode, thereby also lowering the output of the gas sensor element.

To solve the above problems, Japanese Patent Application Publication No 2007-199046 discloses a gas sensor element 91 as shown in FIG. 10. The gas sensor element 91 includes a catalyst layer 92, which contains a noble metal catalyst 921 and is provided on the outer surface of a porous diffusion-resistant layer 914, and a protective layer 93 that is provided on the outer surface of the catalyst layer 92 to collect or trap the poisoning substances contained in the exhaust gas. With the above configuration, when the exhaust gas passes through the catalyst layer 92, part of the hydrogen contained in the exhaust gas will be burnt by the catalysis of the noble metal catalyst 921. Consequently, it is possible to prevent the partial pressure of oxygen at the measurement electrode from becoming lower than the actual partial pressure of oxygen in the exhaust gas, thereby minimizing the output deviation of the gas sensor element 91. However, since there is provided only the single protective layer 93, it is difficult to sufficiently collect the poisoning substances contained in the exhaust gas. Consequently, it is difficult to reliably prevent the porous diffusion-resistant layer 914 from being clogged by the glassy matter and also difficult to reliably prevent the measurement electrode from being poisoned by the particulate matter. As a result, both the responsiveness and output of the gas sensor element 91 may be lowered.

Japanese Patent No. 2957542 discloses a gas sensor element which includes two protective layers so as to sufficiently collect the poisoning substances contained in the exhaust gas. However, this gas sensor element has no means for suppressing the output deviation of the gas sensor element due to the hydrogen contained in the exhaust gas.

### SUMMARY OF THE INVENTION

The present invention has been made in view of the above-described problems with the prior art.

According to a first aspect of the present invention, there is provided a gas sensor element which includes a solid electrolyte body, a measurement electrode, a reference electrode, a porous diffusion-resistant layer, a catalyst layer, and a plurality of protective layers. The solid electrolyte body has oxygen ion conductivity and an opposite pair of first and second surfaces. The measurement electrode is provided on the first surface of the solid electrolyte body so as to be exposed to a measurement gas. The reference electrode is provided on the second surface of the solid electrolyte body so as to be exposed to a reference gas. The porous diffusion-resistant layer is provided so that through it, the measurement gas is introduced to the measurement electrode. The porous diffusion-resistant layer has an outer surface through which the measurement gas flows into the porous diffusion-resistant layer. The catalyst layer is provided on the outer surface of the porous diffusion-resistant layer. The catalyst layer is comprised of a noble metal catalyst and catalyst-supporting particles that support the noble metal catalyst. The protective layers are provided in layers on the catalyst layer. Each of the protective layers is comprised of oxide particles. The average particle diameter of the catalyst-supporting particles of the catalyst layer is less than or equal to the average particle diameter of the oxide particles of the one of the protective layers which adjoins the catalyst layer. The further the protective layers are from the catalyst layer, the larger the average particle diameters of the oxide particles of the protective layers are.

With the above configuration, when the measurement gas is exhaust gas from an internal combustion engine, the glassy matter contained in the exhaust gas which includes larger poisoning particles will, be collected (or trapped) by the outer protective layer(s), and the particulate matter contained in the exhaust gas which includes smaller poisoning particles will be collected by the inner protective layer(s).

Consequently, it is possible to prevent the porous diffusion-resistant layer from being clogged by the glassy matter contained in the exhaust gas, thereby ensuring high gas-permeability of the porous diffusion-resistant layer for a long time. As a result, it is possible to ensure high responsiveness and stable output of the gas sensor element.

Moreover, it is also possible to prevent the measurement electrode from being poisoned and thus deteriorated by the particulate matter contained in the exhaust gas, thereby preventing the output of the gas sensor element from being lowered due to deterioration of the measurement electrode. As a result, it is possible to ensure stable output of the gas sensor element.

Further, with the above configuration, when the exhaust gas filtered by the protective layers passes through the catalyst layer, part of the hydrogen contained in the exhaust gas will be burnt by the catalysis of the noble metal catalyst. Consequently, it is possible to prevent the partial pressure of oxygen at the measurement electrode from becoming lower than the actual partial pressure of oxygen in the exhaust gas, thereby minimizing the output deviation of the gas sensor element. As a result, it is possible ensure high accuracy of the gas sensor element.

Furthermore, in the gas sensor element, the average particle diameter of the catalyst-supporting particles of the catalyst layer is less than or equal to the average particle diameter of the oxide particles of the protective layer that adjoins the catalyst layer. Consequently, it is possible to collect, by using the catalyst layer, those poisoning particles in the particulate matter which are small enough to pass through the protective layer adjoining the catalyst layer. As a result, it is possible to more reliably ensure high responsiveness and stable output of the gas sensor element.

In addition, since the particulate matter contained in the exhaust gas can be collected by the inner protective layer(s), it is also possible to prevent the noble metal catalyst of the catalyst layer from being poisoned and thus deteriorated by the particulate matter. Consequently, it is possible to ensure the catalysis of the noble metal catalyst, thereby reliably minimizing the output deviation of the gas sensor element due to the hydrogen contained in the exhaust gas.

The gas sensor element may be used in an A/F (Air/Fuel) ratio sensor that is disposed in the exhaust system of an internal combustion engine of a motor vehicle to sense the A/F ratio of air-fuel mixture supplied to the engine. More specifically, in this case, the A/F ratio sensor may determine the A/F ratio based on the limit current of the gas sensor element which depends on the concentration of oxygen in the exhaust gas from the engine. Otherwise, the gas sensor element may be used in an oxygen sensor that is disposed in the exhaust system of an internal combustion engine of a motor vehicle to sense the concentration of oxygen in the exhaust gas from the engine. Moreover, the gas sensor element may also be used in a NOx (Nitrogen Oxides) sensor that is disposed in the exhaust system of an internal combustion engine of a motor vehicle to sense the concentration of nitrogen oxides in the exhaust gas from the engine.

In the gas sensor element, as described above, the catalyst layer is comprised of the noble metal catalyst and the catalyst-supporting particles that support the noble metal catalyst. The catalyst layer may be formed by coating the noble metal catalyst on the surfaces of the catalyst-supporting particles. Otherwise, the catalyst layer may be formed by mixing particles of the noble metal catalyst with the catalyst-supporting particles.

It is preferable that the noble metal catalyst of the catalyst layer is made of at least one of Pt, Pd, Rh, Ir, and Ru. In this case, it is possible to ensure excellent catalysis of the noble metal catalyst.

It is also preferable that the catalyst-supporting particles of the catalyst layer are made of α-alumina, γ-alumina, or θ-alumina. In this case, it is possible to minimize the differences in coefficient of thermal expansion between the catalyst layer and other layers of the gas sensor element which sandwich the catalyst layer, thereby ensuring high performance and high reliability of the gas sensor element at high temperatures.

It is more preferable that the catalyst-supporting particles of the catalyst layer are made of α-alumina. This is because α-alumina has a smaller specific surface and higher catalytic activity than γ-alumina and θ-alumina.

It is preferable that the oxide particles of the outermost two of the protective layers are made of γ-alumina or α-alumina. In this case, since both γ-alumina and θ-alumina have a greater specific surface than α-alumina, it is possible for the outermost two protective layers to effectively collect the poisoning substances contained in the measurement gas.

It is further preferable that each of the outermost two protective layers has a thickness greater than or equal to 6 μm. In this case, it is possible for the outermost two protective layers to reliably collect the poisoning substances contained in the measurement gas. By contrast, if the thickness of each of the outermost two protective layers is less than 6 μm, it is difficult to secure a sufficiently long collecting distance for collecting the poisoning substances in each of the outermost two protective layers.

It is also preferable that the average particle diameter of the catalyst-supporting particles of the catalyst layer is greater than 0.3 μm. In this case, it is possible to secure sufficient gas-permeability of the catalyst layer, thereby ensuring high responsiveness of the gas sensor element. By contrast, if the average particle diameter of the catalyst-supporting particles of the catalyst layer is less than or equal to 0.3 μm, it may be difficult to secure sufficient gas-permeability of the catalyst layer and thus difficult to ensure high responsiveness of the gas sensor element. In addition, it may also be difficult to effectively suppress the output deviation due to hydrogen of the gas sensor element.

It is preferable that the average particle diameter of the oxide particles of the outermost one of the protective layers is less than or equal to 30 μm. In this case, it is possible to secure sufficient strength of the outermost protective layer.

It is also preferable that the catalyst layer has a thickness in the range of 2 to 20 μm. In this case, it is possible to effectively suppress the output deviation due to hydrogen of the gas sensor element while ensuring high responsiveness of the gas sensor element. In addition, if the thickness of the catalyst layer is less than 2 μm, it may be difficult to sufficiently burn the hydrogen contained in the measurement gas and thus difficult to effectively suppress the output deviation due to hydrogen of the gas sensor element. On the other hand, if the thickness of the catalyst layer is greater than 20 μm, it may be difficult to secure sufficient gas-permeability of the catalyst layer and thus difficult to ensure high responsiveness of the gas sensor element.

It is preferable that the porous diffusion-resistant layer has a thickness in the range of 5 to 150 μm. In this case, it is possible to ensure both high responsiveness and prompt activation of the gas sensor element. In addition, if the thickness of the porous diffusion-resistant layer is less than 5 μm, it may be difficult to secure a sufficiently large entrance for the measurement gas to flow into the porous diffusion-resistant layer and thus difficult to ensure high responsiveness of the gas sensor element. On the other hand, if the thickness of the porous diffusion-resistant layer is greater than 150 μm, it may be difficult to secure a sufficiently small heat capacity of the gas sensor element and thus difficult to ensure prompt activation of the gas sensor element.

It is also preferable that the catalyst layer has a greater porosity than the porous diffusion-resistant layer. In this case, it is possible to supply a sufficient amount of the measurement gas to the porous diffusion-resistant layer via the catalyst layer, thereby ensuring high responsiveness of the gas sensor element.

It is preferable that the porous diffusion-resistant layer has a porosity in the range of 30 to 60%. In this case, it is possible to ensure both high responsiveness of the gas sensor element and sufficient strength of the porous diffusion-resistant layer. In addition, if the porosity of the porous diffusion-resistant layer is lower than 30%, it may be difficult to secure sufficient gas-permeability of the porous diffusion-resistant layer and thus difficult to ensure high responsiveness of the gas sensor element. On the other hand, if the porosity of the porous diffusion-resistant layer is higher than 60%, it may be difficult to ensure sufficient strength of the porous diffusion-resistant layer.

It is also preferable that the percentage of the outer surface of the porous diffusion-resistant layer being covered by the catalyst layer is higher than or equal to 30%. In this case, it is possible to effectively suppress the output deviation due to hydrogen of the gas sensor element. By contrast, if the percentage is lower than 30%, it may be difficult to sufficiently burn the hydrogen contained in the measurement gas and thus difficult to effectively suppress the output deviation due to hydrogen of the gas sensor element.

According to a second aspect of the present invention, there is provided a gas sensor that is characterized by including the gas sensor element according to the first aspect of the invention to sense the concentration of a specific component in the measurement gas.

It is preferable that the measurement gas is exhaust gas from a direct-injection engine, a turbocharged engine, or a CNG engine. In this case, the measurement gas tends to contain a large amount of hydrogen, and it is therefore possible to fully utilize the capability of the gas sensor element according to the first aspect of the invention to suppress the output deviation due to the hydrogen contained in the exhaust gas.

According to a third aspect of the present invention, there is provided a method of manufacturing the gas sensor element according to the first aspect of the invention. The method is characterized in that in forming the catalyst layer, a material for forming the catalyst layer is applied by printing.

With the above method, since the material for forming catalyst layer is applied by printing, it is possible to accurately apply the material to a desired portion of the outer surface of the porous diffusion-resistant layer. As a result, it is possible to accurately form the catalyst layer on the desired portion of the outer surface of the porous diffusion-resistant layer, thereby ensuring high accuracy, high responsiveness, and stable output of the gas sensor element.

It is preferable that the printing, by which the material for forming the catalyst layer is applied, is pad printing, inkjet printing, or screen printing. Using any one of the three printing methods, it is possible to accurately apply the material to a desired portion of the outer surface of the porous diffusion-resistant layer, thereby accurately forming the catalyst layer on the desired portion.

It is also preferable that the material for forming the catalyst layer has a viscosity higher than or equal to 1 Pa·s. In this case, the material can be reliably applied to the outer surface of the porous diffusion-resistant layer without permeating (or spreading) into the diffusion-resistant layer. By contrast, if the viscosity of the material for forming the catalyst layer is lower than 1 Pa·s, the material may further permeate into the porous diffusion-resistant layer after being applied to the outer surface thereof, thereby lowering the gas-permeability of the diffusion-resistant layer.

It is preferable that in forming each of the protective layers, a material for forming the protective layer is applied by dipping. In this case, it is possible to easily form each of the protective layers.

It is further preferable that in forming each of the protective layers, the material for forming the protective layer has a viscosity lower than or equal to 1 Pa·s. In this case, it is possible to accurately form each of the protective layers in even thickness.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is a cross-sectional view of a gas sensor element according to an embodiment of the invention;

FIG. 2 is a schematic view illustrating the formation of a catalyst layer and protective layers on an outer side surface of a porous diffusion-resistant layer in the gas sensor element;

FIG. 3 is a schematic view illustrating the flow of a measurement gas in the gas sensor element;

FIG. 4 is a cross-sectional view of a gas sensor that includes the gas sensor element of FIG. 1;

FIGS. 5 and 6 are graphical representations showing the results of Experiment 1 of the invention;

FIGS. 7-9 are tabular representations showing the results of Experiments 2-9 of the invention; and

FIG. 10 is a schematic view illustrating the formation of a catalyst layer and a protective layer on an outer side surface of a porous diffusion-resistant layer in a prior art gas sensor element.

### DESCRIPTION OF PREFERRED EMBODIMENT

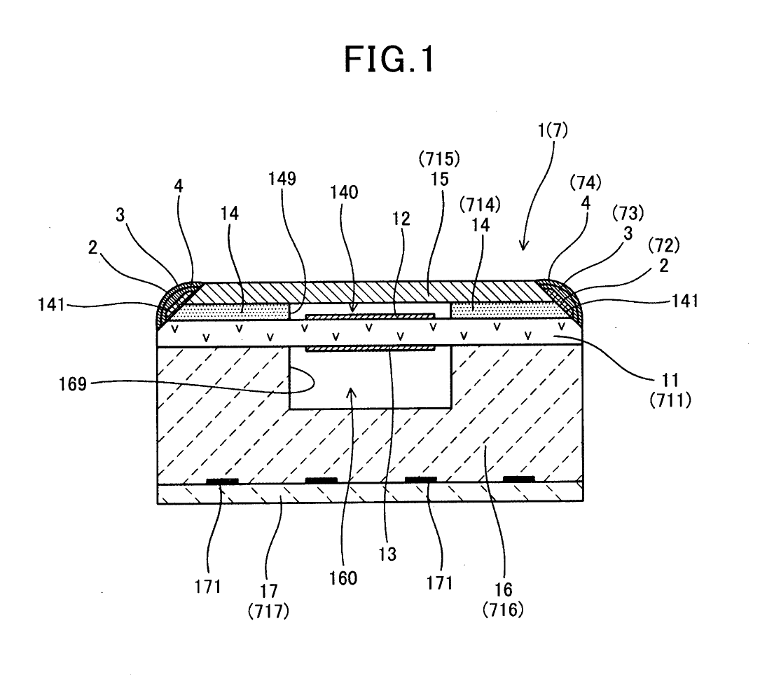

One preferred embodiment of the present invention will be described hereinafter with reference to FIGS. 1-9.

FIG. 1 shows the overall configuration of a gas sensor element 1 according to an embodiment of the invention.

As shown in FIG. 1, the gas sensor element 1 includes a solid electrolyte body 11, a measurement electrode 12, a reference electrode 13, and a porous diffusion-resistant layer 14. The solid electrolyte body 11 has oxygen ion conductivity and an opposite pair of first and second surfaces (i.e., the upper and lower surfaces in FIG. 1). The measurement electrode 12 is provided on the first surface of the solid electrolyte body 11 so as to be exposed to a measurement gas. The reference electrode 13 is provided on the second surface of the solid electrolyte body 11 so as to be exposed to a reference gas. The porous diffusion-resistant layer 14 is provided on the first surface of the solid electrolyte body 11 around the measurement electrode 12, so that the measurement gas is introduced to the measurement electrode 12 through the porous diffusion-resistant layer 14. In addition, in the present embodiment, the measurement gas is exhaust gas from an internal combustion engine, and the reference gas is air.

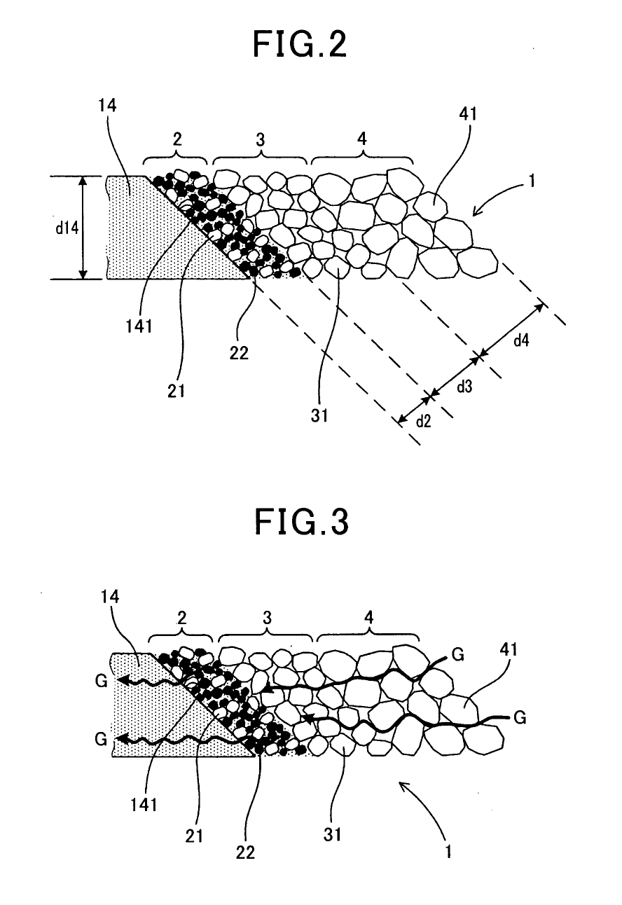

Referring now to FIG. 2 together with FIG. 1, the gas sensor element 1 further includes a catalyst layer 2 and a plurality of protective layers (more particularly, first and second protective layers 3 and 4 in the present embodiment). The catalyst layer 2 is provided on an outer side surface 141 of the porous diffusion-resistant layer 14, through which the measurement gas flows into the porous diffusion-resistant layer 14. The catalyst layer 2 is comprised of catalyst-supporting particles 21 and a noble metal catalyst 22 that is supported by the catalyst-supporting particles 21. The first protective layer 3 is provided on the catalyst layer 2, and the second protective layer 4 is provided on the first protective layer 4. In other words, the protective layers are provided in layers on the catalyst layer 2. The protective layer 3 is comprised of oxide particles 31, and the protective layer 4 is comprised of oxide particles 41. The average particle diameter of the oxide particles 31 is different from that of the oxide particles 41.

More specifically, in the present embodiment, the average particle diameter of the catalyst-supporting particles 21 of the catalyst layer 2 is less than or equal to that of the oxide particles 31 of the first protective layer 3. The average particle diameter of the oxide particles 31 of the first protective layer 3 is less than that of the oxide particles 41 of the second protective layer 4. That is, the further the protective layers are from the catalyst layer 2, the larger the average particle diameters of the oxide particles of the protective layers are.

Hereinafter, the configuration of the gas sensor element 1 according to the present embodiment will be described in detail.

As shown in FIG. 1, in the gas sensor element 1, the measurement and reference electrodes 12 and 13 are respectively provided on the first and second surfaces of the solid electrolyte body 11 that has oxygen ion conductivity. The solid electrolyte body 11 is made of, for example, zirconia. Both the measurement and reference electrodes 12 and 13 are made of, for example, platinum (Pt).

The porous diffusion-resistant layer 14 is made of, for example, gas-permeable porous alumina. The diffusion-resistant layer 14 has an opening portion 149 that faces the measurement electrode 12. Moreover, as shown in FIG. 2, the diffusion-resistant layer 14 has a thickness d14 in the range of 5 to 150 μm and a porosity in the range of 30 to 60%.

The gas sensor element 1 further includes a shield layer 15, a reference gas chamber formation layer 16, and a heater substrate 17. The gas sensor element 1 also has both a measurement gas chamber 140 and a reference gas chamber 160 formed therein.

The shield layer 15 is provided on the surface of the porous diffusion-resistant layer 14 on the opposite side to the solenoid electrolyte body 11. The shield layer 15 is made of, for example, dense alumina that is gas impermeable and electrically insulative.

Between the solid electrolyte body 11, the opening portion 149 of the porous diffusion-resistant layer 14, and the shield layer 15, there is formed a hollow space which makes up the measurement gas chamber 140. During operation of the gas sensor element 1, the measurement gas chamber 140 will be filled with the measurement gas which is introduced thereinto via the porous diffusion-resistant layer 14; thus, the measurement electrode 12 will be accordingly exposed to the measurement gas.

The reference gas chamber formation layer 16 is provided on the second surface (i.e., the lower surface in FIG. 1) of the solid electrolyte body 11. The reference gas chamber formation layer 16 is made of, for example, dense alumina that is gas impermeable and electrically insulative. In the reference gas chamber formation layer 16, there is formed a recess 169 for making up the reference gas chamber 160. During operation of the gas sensor element 1, the reference gas chamber 160 will be filled with the reference gas which is introduced thereinto via an opening (not shown) of the chamber 160; thus, the reference electrode 13 will be accordingly exposed to the reference gas.

The heater substrate 17 is provided on the surface of the reference gas chamber formation layer 16 on the opposite side to the solid electrolyte body 11. A plurality of electrical heating elements 171 are provided in the heater substrate 17 so as to face the reference gas chamber formation layer 16. During a starting operation of the engine, the heating elements 171 will be supplied with electric power to generate heat, thereby heating the gas sensor element 1 to its activation temperature.

The catalyst layer 2 is provided on the outer side surface 141 of the porous diffusion-resistant layer 14, through which the measurement gas flows into the porous diffusion-resistant layer 14. The percentage of the outer side surface 141 of the diffusion-resistant layer 14 being covered by the catalyst layer 2 is greater than or equal to 30%.

The catalyst layer 2 is formed of a mixture of the catalyst-supporting particles 21 and particles of the noble metal catalyst 22. In the present embodiment, the catalyst-supporting particles 21 are made of α-alumina and have an average particle diameter of 1.5 μm. The noble metal catalyst 22 is made of platinum (Pt), palladium (Pd), and rhodium (Rh) which are alloyed or mixed together. Moreover, the catalyst layer 2 has a thickness d2 in the range of 2 to 20 μm and a porosity greater than that of the porous diffusion-resistant layer 14.

On the catalyst layer 2, there are sequentially provided the first and second protective layers 3 and 4. The first protective layer 3 is comprised of the first oxide particles 31 that are made of θ-alumina and have an average particle diameter in the range of 2 to 10 μm. The first protective layer 3 has a thickness d3 greater than or equal to 6 μm. On the other hand, the second protective layer 4 is comprised of the second oxide particles 41 that are made of θ-alumina and have an average particle diameter of 15 to 25 μm. The second protective layer 4 has a thickness d4 greater than or equal to 6 μm.

After having described the configuration of the gas sensor element 1, a method of manufacturing it according to the present embodiment will be described. The method includes the following five steps.

In the first step, referring to FIG. 1, ceramic sheets 715, 714, 711, 716, and 717 are prepared for respectively forming the porous diffusion-resistant layer 14, the shield layer 15, the solid electrolyte body 11, the reference gas chamber formation layer 16, and the heater substrate 17. Then, the ceramic sheets 715, 714, 711, 716, and 717 are sequentially laminated to form a laminate, which is further fired to form a fired laminate 7.

In the second step, paste 72 for forming the catalyst layer 2 is applied to the outer side surface 141 of the porous diffusion-resistant layer 14 by pad printing, inkjet printing, or screen printing. In addition, the paste 72 has a viscosity higher than or equal to 1 Pa·s.

In the third step, the fired laminate 7 is dipped in first slurry 73 for forming the first protective layer 3. Consequently, the first slurry 73 is applied, by dipping, on the paste 72 for forming the catalyst layer 2. In addition, the first slurry 73 has a viscosity lower than or equal to 1 Pa·s.

In the fourth step, the fired laminate 7 is further dipped in second slurry 74 for forming the second protective layer 4. Consequently, the second slurry 74 is applied, by dipping, on the first slurry 73 for forming the first protective layer 3. In addition, the second slurry 74 has a viscosity lower than or equal to 1 Pa·s.

In the fifth step, the fired laminate 7, which has the paste 72 for forming the catalyst layer 2, the first slurry 73 for forming the first protective layer 3, and the second slurry 74 for forming the second protective layer 4 sequentially applied to the outer side surface 141 of the porous diffusion-resistant layer 14, is heat-treated, thereby forming the gas sensor element 1 as shown in FIGS. 1 and 2.

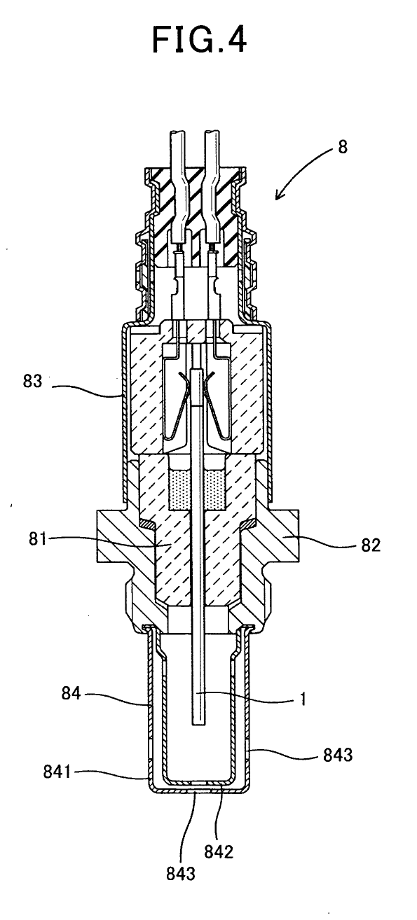

Next, a gas sensor 8 which has the gas sensor element 1 incorporated therein will be described with reference to FIG. 4.

The gas sensor 8 includes, in addition to the gas sensor element 1, an insulator 81, a housing 82, a base-side cover 83, and a tip-side cover 84. The insulator 81 has the gas sensor element I partially inserted and held therein. The housing 82 has the insulator 81 partially inserted and held therein. The base-side cover 83 is fixed to a base end (i.e., the upper end in FIG. 4) of the housing 82 to protect that part of the insulator 81 which protrudes from the base end of the housing 81. The tip-side cover 84 is fixed to a tip end (i.e., the lower end in FIG. 4) of the housing 82 to protect that part of the gas sensor element 1 which protrudes from the tip end of the housing 82. The tip-side cover 84 is a double cover consisting of an outer cover 841 and an inner cover 842. Each of the inner and outer covers 841 and 842 has through-holes 843 formed through its end and side walls. During operation of the gas sensor 8, the measurement gas will be introduced to the gas sensor element 1 through the through-holes 843 of the inner and outer covers 841 and 842.

According to the present embodiment, it is possible achieve the following advantages.

The gas sensor element 1 according to the present embodiment includes the catalyst layer 2 provided on the outer side surface 141 of the porous diffusion-resistant layer 14 and the first and second protective layers 3 and 4 provided in layers on the catalyst layer 2. The catalyst layer 2 is comprised of the catalyst-supporting particles 21 and the noble metal catalyst 22 that is supported by the catalyst-supporting particles 21. The protective layer 3 is comprised of the oxide particles 31, and the protective layer 4 is comprised of the oxide particles 41. The average particle diameter of the catalyst-supporting particles 21 of the catalyst layer 2 is less than or equal to that of the oxide particles 31 of the first protective layer 3. The average particle diameter of the oxide particles 31 of the first protective layer 3 is less than that of the oxide particles 41 of the second protective layer 4.

With the above configuration, when the exhaust gas G from the internal combustion engine (i.e., the measurement gas) passes through the protective layers 3 and 4, as shown in FIG. 3, the glassy matter contained in the exhaust gas which includes larger poisoning particles will be collected (or trapped) by the second protective layer 4, and the particulate matter contained in the exhaust gas which includes smaller poisoning particles will be collected by the first protective layer 3.

Consequently, it is possible to prevent the porous diffusion-resistant layer 14 from being clogged by the glassy matter contained in the exhaust gas, thereby ensuring high gas-permeability of the porous diffusion-resistant layer 14 for a long time. As a result, it is possible to ensure high responsiveness and stable output of the gas sensor element 1.

Moreover, it is also possible to prevent the measurement electrode 12 from being poisoned and thus deteriorated by the particulate matter contained in the exhaust gas, thereby preventing the output of the gas sensor element 1 from being lowered due to deterioration of the measurement electrode 12. As a result, it is possible to ensure stable output of the gas sensor element 1.

Further, with the above configuration, when the exhaust gas G filtered by the protective layers 3 and 4 passes through the catalyst layer 2, part of the hydrogen contained in the exhaust gas G will be burnt by the catalysis of the noble metal catalyst 22. Consequently, it is possible to prevent the partial pressure of oxygen at the measurement electrode 12 from becoming lower than the actual partial pressure of oxygen in the exhaust gas G, thereby minimizing the output deviation of the gas sensor element 1. As a result, it is possible ensure high accuracy of the gas sensor element 1.

Furthermore, since the average particle diameter of the catalyst-supporting particles 21 of the catalyst layer 2 is less than or equal to that of the oxide particles 31 of the first protective layer 3, it is possible to collect, by the catalyst layer 3, those poisoning particles in the particulate matter which are small enough to pass through the first protective layer 3. Consequently, it is possible to more reliably ensure high responsiveness and stable output of the gas sensor element 1.

In addition, since the particulate matter contained in the exhaust gas G can be collected by the first protective layer 3, it is also possible to prevent the noble metal catalyst 22 of the catalyst layer 2 from being poisoned and thus deteriorated by the particulate matter. Consequently, it is possible to ensure the catalysis of the noble metal catalyst 22, thereby reliably minimizing the output deviation of the gas sensor element 1 due to the hydrogen contained in the exhaust gas G.

The gas sensor 8 according to the present embodiment includes the gas sensor element 1 having the above-described advantages. Accordingly, the gas sensor 8 has high performance and high reliability.

It is preferable that the gas sensor 8 is used in an internal combustion engine exhaust gas from which tends to contain a large amount of hydrogen, such as a direct-injection engine in which fuel is directly injected into the combustion chambers, a turbocharged engine that is equipped with an exhaust turbocharger, and a CNG engine that runs on CNG. In this case, it is possible to fully utilize the capability of the gas sensor element 1 to suppress the output deviation due to the hydrogen contained in the exhaust gas.

In the method of manufacturing the gas sensor element 1 according to the present embodiment, the paste 72 for forming the catalyst layer 2 is applied to the outer side surface 141 of the porous diffusion-resistant layer 14 by printing. Consequently, it is possible to accurately apply the paste 72 to a desired portion of the outer side surface 141. As a result, it is possible to accurately form the catalyst layer 2 on the desired portion of the outer side surface 141 of the porous diffusion-resistant layer 14, thereby ensuring high responsiveness and accuracy of the gas sensor element 1.

Further, it is preferable that the paste 72 for forming the catalyst layer 2 is applied to the outer side surface 141 of the porous diffusion-resistant layer 14 by pad printing, inkjet printing, or screen printing. Using any one of the three printing methods, it is possible to accurately apply the paste 72 to a desired portion of the outer side surface 141, thereby accurately forming the catalyst layer 2 on the desired portion.

In the present embodiment, the paste 72 for forming the catalyst layer 2 has a viscosity higher than or equal to 1 Pa·s. Consequently, the paste 72 can be reliably applied to the outer side surface 141 of the porous diffusion-resistant layer 14 without permeating (or spreading) into the diffusion-resistant layer 14.

In the present embodiment, the first slurry 73 for forming the first protective layer 3 is applied by dipping. Consequently, it is possible to easily form the first protective layer 3 on the catalyst layer 2.

Further, the first slurry 73 for forming the first protective layer 3 has a viscosity lower than or equal to 1 Pa·s. Consequently, it is possible to accurately form the first protective layer 3 in even thickness.

In the present embodiment, the second slurry 74 for forming the second protective layer 4 is also applied by dipping. Consequently, it is possible to easily form the second protective layer 4 on the first protective layer 3.

Further, the second slurry 74 for forming the second protective layer 4 also has a viscosity lower than or equal to 1 Pa·s. Consequently, it is possible to accurately form the second protective layer 4 in even thickness.

### Experiment 1

This experiment has been conducted to investigate the output deviation due to hydrogen and the percentage of output decrease due to poisoning substances of the gas sensor element 1 according to the previous embodiment.

In the experiment, ten gas sensor samples E11 and ten gas sensor samples C11 were tested. Each of the samples E11 included the gas sensor element 1 according to the previous embodiment which had the catalyst layer 2, the first protective layer 3, and the second protective layer 4 formed in layers on the output side surface 141 of the porous diffusion-resistant layer 14. In comparison, each of the samples C11 included a gas sensor element that lacks only the second protective layer 4 in comparison with the gas sensor element 1.

First, for each of the samples E11 and C11, the output deviation due to hydrogen was determined after an endurance test. Specifically, in the endurance test, the sample was installed to the exhaust system of an engine; then, the engine was run at between 1000 and 5000 rpm for a predetermined time on a fuel that included 100-300 ppm of Pb, 200-500 ppm of Si, and 7000-10000 ppm of an engine oil-based poisoning substance in which the ratio of P:Zn:Ca:K was 4:4:1:0.4. After the endurance test, the output of the sample was measured in a stoichiometric atmosphere, and the deviation of the measured output from the correct value corresponding to the stoichiometric air/fuel ratio was computed as the output deviation of the sample. Then, the ratio of the output deviation of the sample to the output deviation of a gas sensor sample, which included a gas sensor element only lacking the catalyst layer in comparison with the gas sensor element 1, was computed as the relative output deviation due to hydrogen of the sample. Thereafter, the relative output deviation due to hydrogen of the sample was repeatedly determined in the above-described manner by setting the endurance test time to different values up to 200 hours.

Next, for each of the samples E11 and C11, the percentage of output decrease due to poisoning substances was determined as follows. First, the output of the sample was measured in the atmosphere with the temperature of the gas sensor element of the sample being equal to 700° C. Then, the same endurance test as described above was performed for the sample for 200 hours, and the output of the sample was measured again in the atmosphere with temperature of the gas sensor element being equal to 700° C. Thereafter, the ratio of the difference between the outputs of the sample before and after the endurance test to the output of the sample before the endurance test was computed as the percentage of output decrease due to poisoning substances of the sample.

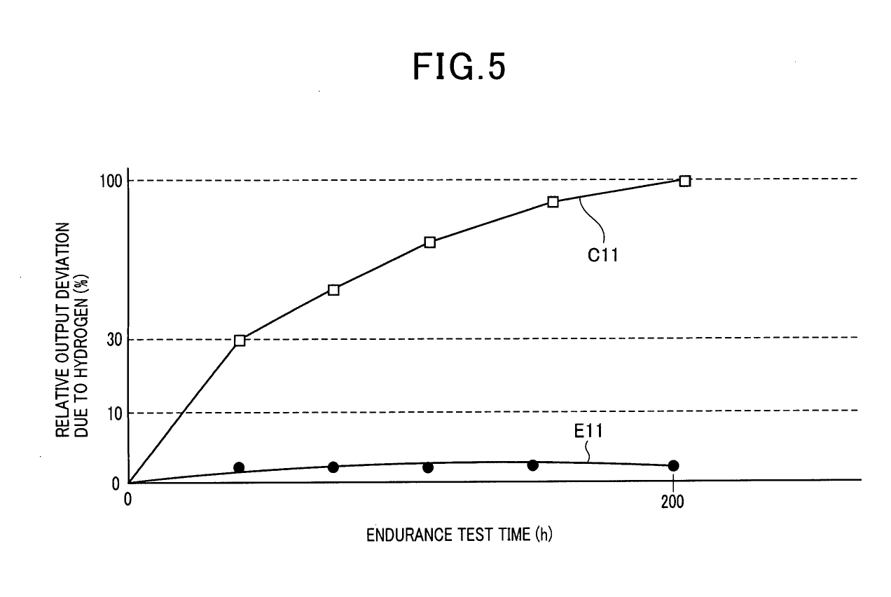

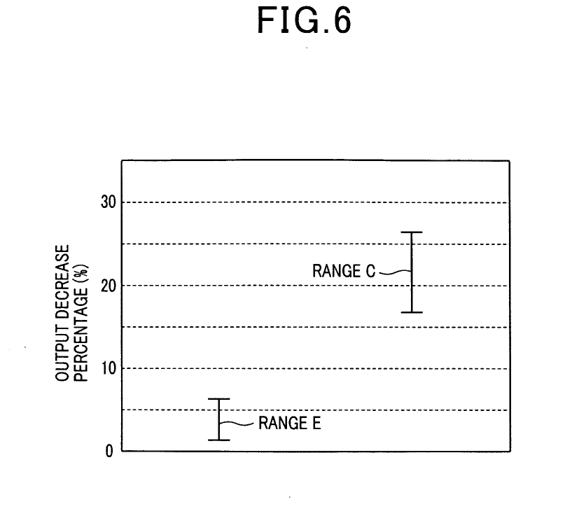

The test results for the samples C11 and E11 are shown in FIGS. 5 and 6. Specifically, in FIG. 5, the curve E11 represents the average values of the relative output deviations due to hydrogen of all the samples E11, whereas the curve C11 represents the average values of the relative output deviations due to hydrogen of all the samples C11. In FIG. 6, the range E represents that range in which the percentages of output decrease of all the samples E11 fall, whereas the range C represents that range in which the percentages of output decrease of all the samples C11 fall. In other words, the range E has its upper and lower limits respectively representing the maximum and minimum values of the percentages of output decrease of all the samples E11, whereas the range C has its upper and lower limits respectively representing the maximum and minimum values of the percentages of output decrease due to poisoning substances of all the samples C11.

As can be seen from FIG. 5, for the gas sensor samples C11 each including a gas sensor element without the second protective layer 4, the relative output deviations due to hydrogen increase with the endurance test time, and reach 100% when the endurance test time exceeds 200 hours. In comparison, for the gas sensor samples E11 each including the gas sensor element 1 according to the previous embodiment, the relative output deviations due to hydrogen hardly increase with the endurance test time, and remain below 10% when the endurance test time exceeds 200 hours.

Moreover, as can be seen from FIG. 6, for the gas sensor samples C11, the percentages of output decrease due to poisoning substances are around 20%, and the range C in which the percentages of output decrease due to poisoning substances vary is relatively large. In comparison, for the gas sensor samples E11, the percentages of output decrease due to poisoning substances are below 10%, and the range E in which the percentages of output decrease due to poisoning substances vary is relatively small.

Accordingly, it is made clear from the above that the gas sensor element 1 according to the previous embodiment can effectively suppress the output deviation thereof due to the hydrogen contained exhaust gas and prevent the output thereof from being lowered due to the poisoning substances contained in the exhaust gas.

### Experiment 2

This experiment has been conducted to investigate the effects of the configuration of catalyst layer and protective layers of a gas sensor element on the output deviation due to hydrogen and the output decrease due to poisoning substances of the gas sensor element.

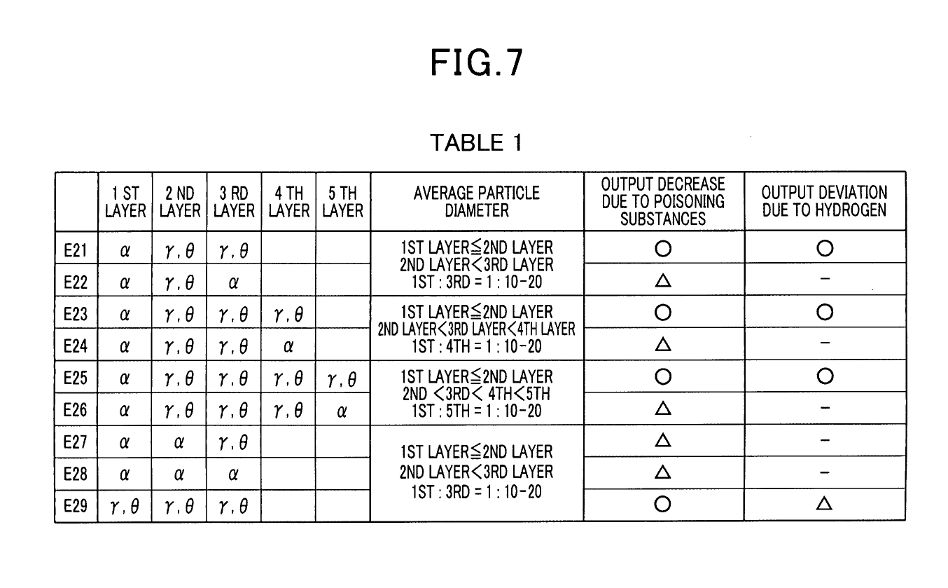

In the experiment, gas sensor samples E21-E29 were tested which included different gas sensor elements. Specifically, the gas sensor elements of the samples E21-E29 had different configurations of catalyst layer and protective layers as shown in Table 1 of FIG. 7.

In Table 1, “1ST LAYER” represents the catalyst layer formed on the outer side surface of the porous diffusion-resistant layer of the gas sensor element and “2ND LAYER” to “5TH LAYER” respectively represent the second to the fourth protective layers sequentially formed on the catalyst layer; α, γ, and θ respectively represent α-alumina, γ-alumina, and θ-alumina; and symbols “a” and “Δ” respectively denote “preferable” and “not preferable”.

It can be seen from Table 1 that: the gas sensor elements of the samples E21, E22, and E27-E29 included two protective layers; those of the samples E23 and E24 included three protective layers; and those of the samples E25 and E26 included four protective layers.

In the experiment, for each of the samples E21-E29, the percentage of output decrease due to poisoning substances was determined in the same manner as described in Experiment 1. Then, the gas sensor element of the sample was evaluated, in terms of output decrease due to poisoning substances, as being preferable when the determined percentage of output decrease due to poisoning substances was lower than or equal to 10%, and as being not preferable otherwise.

Next, for each of the samples E21, E23, E25, and E29, the relative output deviation due to hydrogen was determined in the same manner as described in Experiment 1 with the endurance test time set to 200 hours. Then, the gas sensor element of the sample was evaluated, in terms of output deviation due to hydrogen, as being preferable when the determined relative output deviation due to hydrogen was lower than or equal to 10%, and as being not preferable otherwise.

As can be seen from Table 1, the gas sensor elements of the samples E21, E23, E25, and E29, in each of which the outermost two protective layers were comprised of oxide particles made of γ-alumina or θ-alumina, were evaluated as being preferable in terms of output decrease due to poisoning substances. In contrast, the gas sensor elements of the samples E22, E24, and E26-E28, in each of which either of the outermost two protective layers was comprised of oxide particles made of α-alumina, were evaluated as being not preferable in terms of output decrease due to poisoning substances.

That is to say, to reliably prevent the output of a gas sensor element from being lowered due to the poisoning substances contained in the exhaust gas, it is preferable that the outermost two protective layers of the gas sensor element are comprised of oxide particles made of γ-alumina or θ-alumina.

Moreover, as also can be seen from Table 1, the gas sensor elements of the samples E21, E23, and E25, in each of which the catalyst-supporting particles of the catalyst layer were made of α-alumina, were evaluated as being preferable in terms of output deviation due to hydrogen. In contrast, the gas sensor element of the sample E29, in which the catalyst-supporting particles of the catalyst layer were made of γ-alumina or θ-alumina, was evaluated as being not preferable in terms of output deviation due to hydrogen.

That is to say, to effectively suppress the output deviation of a gas sensor element due to the hydrogen contained in the exhaust gas, it is preferable that the catalyst-supporting particles of the catalyst layer of the gas sensor element are made of α-alumina.

### Experiment 3

This experiment has been conducted to investigate the relationship between the thicknesses of the outermost two protective layers of a gas sensor element and the output decrease due to poisoning substances of the gas sensor element.

In the experiment, two groups of gas sensor samples were tested; each of all the gas sensor samples included a gas sensor element having only first and second protective layers sequentially formed on the outer side surface of the porous diffusion-resistant layer.

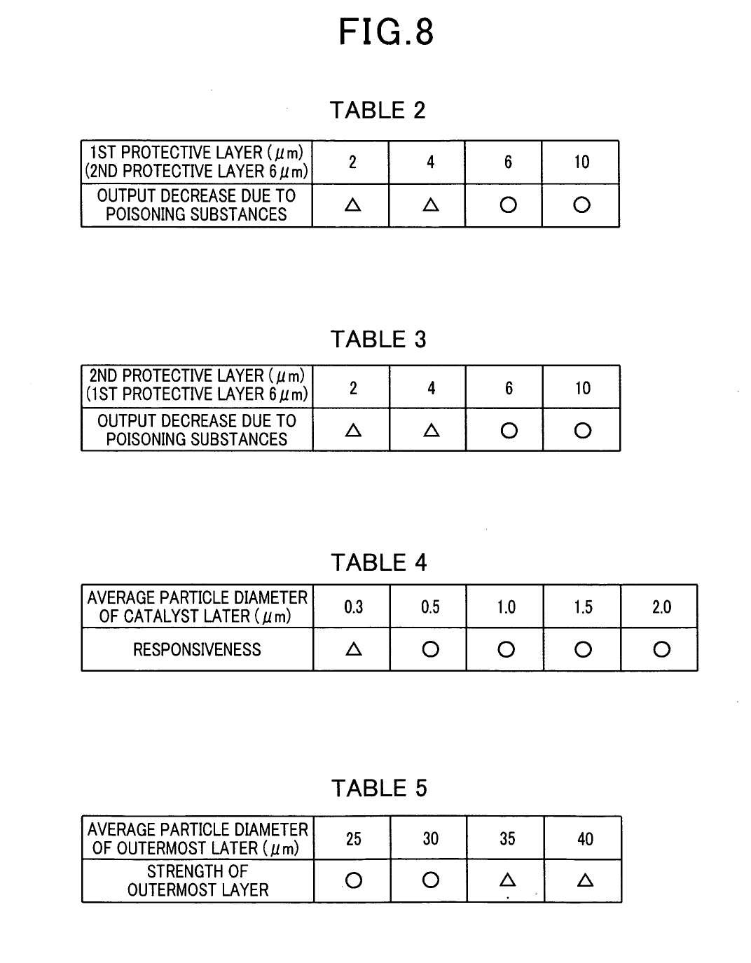

For the gas sensor elements of the samples of the first group, as shown in Table 2 of FIG. 8, the thicknesses of the first protective layers were differently set in the range of 2 to 10 μm, whereas the thicknesses of the second protective layers were equally set to 6 μm.

On the other hand, for the gas sensor elements of the samples of the second group, as shown in Table 3 of FIG. 8, the thicknesses of the first protective layers were equally set to 6 μm, whereas the thicknesses of the second protective layers were differently set in the range of 2 to 10 μm.

In the experiment, for each of all, the samples of the first and second groups, the percentage of output decrease due to poisoning substances was determined in the same manner as described in Experiment 1. Then, the gas sensor element of the sample was evaluated, in terms of output decrease due to poisoning substances, as being preferable when the determined percentage of output decrease due to poisoning substances was lower than or equal to 10%, and as being not preferable otherwise.

As can be seen from Tables 2 and 3, those gas sensor elements, in which either of the thicknesses of the first and second protective layers was set to be less than or equal to 4 μm, were evaluated as being not preferable in terms of output decrease due to poisoning substances. In contrast, those gas sensor elements, in which both the thicknesses of the first and second protective layers were set to be greater than or equal to 6 μm, were evaluated as being preferable in terms of output decrease due to poisoning substances.

Accordingly, it is made clear from the above that to reliably prevent the output of a gas sensor element from being lowered due to the poisoning substances contained in the exhaust gas, it is preferable to set each of the thicknesses of the outermost two protective layers of the gas sensor element to be greater than or equal to 6 μm.

### Experiment 4

This experiment has been conducted to investigate the relationship between the average particle diameter of the catalyst-supporting particles of the catalyst layer of a gas sensor element and the responsiveness of the gas sensor element.

In the experiment, a plurality of gas sensor samples were tested; each of the samples included a gas sensor element in which the catalyst-supporting particles of the catalyst layer was made of α-alumina. Moreover, the average particle diameters of the catalyst-supporting particles of the catalyst layers of the samples were differently set in the range of 0.3 to 2.0 μm, as shown in Table 4 of FIG. 8.

For each of the samples, a response time was measured from when a concentration change of the measurement gas of the sample occurred to when an output change of the sample corresponding to the concentration change occurred. Then, the ratio of the difference between the response times of the sample and a comparative sample to the response time of the comparative sample was computed as the relative response delay of the sample; the comparative sample had no catalyst layer formed therein. Thereafter, the gas sensor element of the sample was evaluated, in terms of responsiveness, as being preferable when the relative response delay of the sample was lower than 5% and as being not preferable otherwise.

As can be seen from Table 4, the gas sensor element, in which the average particle diameter of the catalyst-supporting particles of the catalyst layer was equal to 0.3 μm, was evaluated as being not preferable. In contrast, those gas sensor elements, in which the average particle diameter of the catalyst-supporting particles of the catalyst layer was greater than or equal to 0.5 μm, were evaluated as being preferable.

Accordingly, it is made clear from the above that to ensure high responsiveness of a gas sensor element, it is preferable to set the average particle diameter of the catalyst-supporting particles of the catalyst layer of the gas sensor element to be greater than 0.3 μm.

### Experiment 5

This experiment has been conducted to investigate the relationship between the average particle diameter of the oxide particles of the outermost protective layer of a gas sensor element and the strength of the outermost protective layer.

In the experiment, a plurality of gas sensor samples were tested; each of the samples included a gas sensor element in which the oxide particles of the second protective layer (i.e., the outermost protective layer) was made of θ-alumina. Moreover, the average particle diameters of the oxide particles of the outermost protective layers of the samples were differently set in the range of 25 to 40 μm, as shown in Table 5 of FIG. 8.

For each of the samples, the strength of the outermost protective layer was visually examined after an endurance test that was conducted for 200 hours in the same manner as described in Experiment 1. Then, the gas sensor element of the sample was evaluated, in terms of the strength of the outermost protective layer, as being preferable when no defect of the outermost protective layer was found and as being not preferable when a defect (e.g., peeling) of the same was found.

As can be seen from Table 5, those gas sensor elements, in which the average particle diameter of the oxide particles of the outermost protective layer was equal to 25 or 30 μm, were evaluated as being preferable. In contrast, those gas sensor elements, in which the average particle diameter of the oxide particles of the outermost protective layer was equal to 35 or 40 μm, were evaluated as being not preferable.

Accordingly, it is made clear from the above that to ensure sufficient strength of the outermost protective layer of a gas sensor element, it is preferable to set the average particle diameter of the oxide particles of the outermost protective layer to be less than or equal to 30 μm.

### Experiment 6

This experiment has been conducted to investigate the effects of the thickness of the catalyst layer of a gas sensor element on the output deviation due to hydrogen and the responsiveness of the gas sensor element.

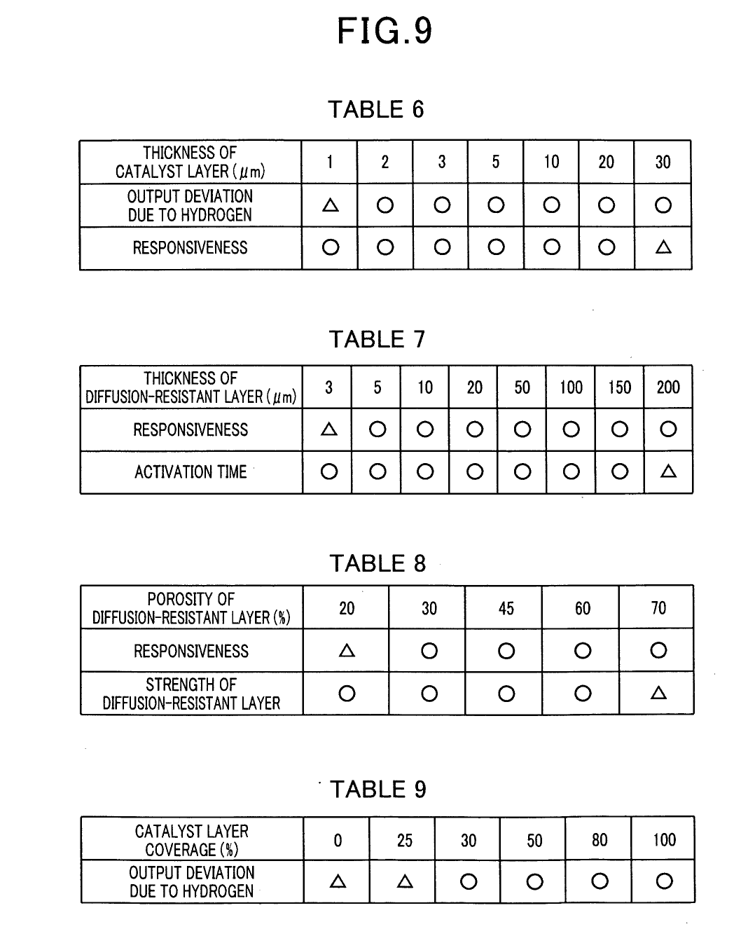

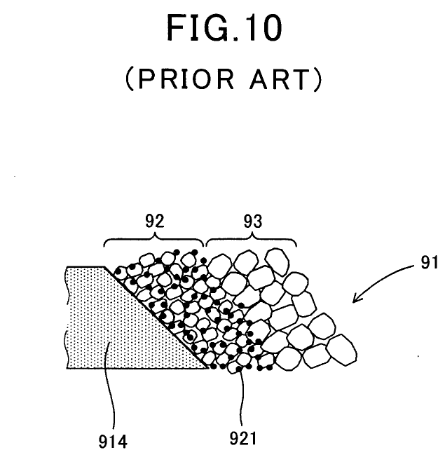

In the experiment, a plurality of gas sensor samples were tested which included different gas sensor elements. Specifically, the thicknesses of the catalyst layers of the gas sensor elements were differently set in the range of 1 to 30 μm, as shown in Table 6 of FIG. 9.

First, for each of the samples, the relative output deviation due to hydrogen was determined in the same manner as described in Experiment 1 with the endurance test time set to 200 hours. Then, the gas sensor element of the sample was evaluated, in terms of output deviation due to hydrogen, as being preferable when the determined relative output deviation due to hydrogen was lower than or equal to 10%, and as being not preferable otherwise.

Next, for each of the samples, the relative response delay was determined in the same manner as described in Experiment 4. Then, the gas sensor element of the sample was evaluated, in terms of responsiveness, as being preferable when the relative response delay of the sample was lower than 5% and as being not preferable otherwise.

As can be seen from Table 6, the gas sensor element, in which the thickness of the catalyst layer was equal to 1 μm, was evaluated as being not preferable in terms of output deviation due to hydrogen. In contrast, those gas sensor elements, in which the thickness of the catalyst layer was greater than or equal to 2 μm, was evaluated as being preferable in terms of output deviation due to hydrogen.

Moreover, as also can be seen from Table 6, the gas sensor element, in which the thickness of the catalyst layer was equal to 30 μm, was evaluated as being not preferable in terms of responsiveness. In contrast, those gas sensor elements, in which the thickness of the catalyst layer was less than or equal to 20 μm, was evaluated as being preferable in terms of responsiveness.

Accordingly, it is made clear from the above that to effectively suppress the output deviation due to hydrogen of a gas sensor element while ensuring high responsiveness of the gas sensor element, it is preferable to set the thickness of the catalyst layer of the gas sensor element to be in the range of 2 to 20 μm.

### Experiment 7

This experiment has been conducted to investigate the effects of the thickness of the porous diffusion-resistant layer of a gas sensor element on the responsiveness and activation time of the gas sensor element.

In the experiment, a plurality of gas sensor samples were tested which included different gas sensor elements. Specifically, the thicknesses of the porous diffusion-resistant layers of the gas sensor elements were differently set in the range of 3 to 200 μm, as shown in Table 7 of FIG. 9.

First, for each of the samples, the relative response delay was determined in the same manner as described in Experiment 4. Then, the gas sensor element of the sample was evaluated, in terms of responsiveness, as being preferable when the relative response delay of the sample was lower than 5% and as being not preferable otherwise.

Next, far each of the samples, the length of time required for the temperature of the gas sensor element of the sample to reach 700° C. in the atmosphere was measured. Then, the gas sensor element of the sample was evaluated, in terms of activation time, as being preferable when the measured length of time was shorter than or equal to 10 seconds and as being not preferable otherwise.

As can be seen from Table 7, the gas sensor element, in which the thickness of the porous diffusion-resistant layer was equal to 3 μm, was evaluated as being not preferable in terms of responsiveness. In contrast, those gas sensor elements, in which the thickness of the porous diffusion-resistant layer was greater than or equal to 5 μm, was evaluated as being preferable in terms of responsiveness.

Moreover, as also can be seen from Table 7, the gas sensor element, in which the thickness of the porous diffusion-resistant layer was equal to 200 μm, was evaluated as being not preferable in terms of activation time. In contrast, those gas sensor elements, in which the thickness of the porous diffusion-resistant layer was less than or equal to 150 μm, was evaluated as being preferable in terms of activation time.

Accordingly, it is made clear from the above that to ensure both high responsiveness and prompt activation of a gas sensor element, it is preferable to set the thickness of the porous diffusion-resistant layer of the gas sensor element to be in the range of 5 to 150 μm.

### Experiment 8

This experiment has been conducted to investigate the effects of the porosity of the porous diffusion-resistant layer of a gas sensor element on the responsiveness of the gas sensor element and the strength of the porous diffusion-resistant layer.

In the experiment, a plurality of gas sensor samples were tested which included different gas sensor elements. Specifically, the porosities of the porous diffusion-resistant layers of the gas sensor elements were differently set in the range of 20 to 70%, as shown in Table 8 of FIG. 9. In addition, in each of the gas sensor elements, the porosity of the catalyst layer was greater than that of the porous diffusion-resistant layer.

First, for each of the samples, the relative response delay was determined in the same manner as described in Experiment 4. Then, the gas sensor element of the sample was evaluated, in terms of responsiveness, as being preferable when the relative response delay of the sample was lower than 5% and as being not preferable otherwise.

Next, for each of the samples, the strength of the porous diffusion-resistant layer was visually examined after an endurance test that was conducted for 200 hours in the same manner as described in Experiment 1. Then, the gas sensor element of the sample was evaluated, in terms of the strength of the porous diffusion-resistant layer, as being preferable when no defect of the porous diffusion-resistant layer was found and as being not preferable when a defect (e.g., peel-off) of the same was found.

As can be seen from Table 8, the gas sensor element, in which the porosity of the porous diffusion-resistant layer was equal to 20%, was evaluated as being not preferable in terms of responsiveness. In contrast, those gas sensor elements, in which the porosity of the porous diffusion-resistant layer was greater than or equal to 30%, was evaluated as being preferable in terms of responsiveness.

Moreover, as also can be seen from Table 8, the gas sensor element, in which the porosity of the porous diffusion-resistant layer was equal to 70%, was evaluated as being not preferable in terms of the strength of the porous diffusion-resistant layer. In contrast, those gas sensor elements, in which the porosity of the porous diffusion-resistant layer was less than or equal to 60%, was evaluated as being preferable in terms of the strength of the porous diffusion-resistant layer.

Accordingly, it is made clear from the above that to ensure both high responsiveness of a gas sensor element and sufficient strength of the porous diffusion-resistant layer of the gas sensor element, it is preferable to set the porosity of the porous diffusion-resistant layer to be in the range of 30 to 60%.

### Experiment 9

This experiment has been conducted to investigate the relationship between the catalyst layer coverage (i.e., the percentage of the outer side surface of the porous diffusion-resistant layer being covered by the catalyst layer) in a gas sensor element and the output deviation due to hydrogen of the gas sensor element.

In the experiment, a plurality of gas sensor samples were tested which included different gas sensor elements. Specifically, the catalyst layer coverages in the gas sensor elements were differently set in the range of 0 to 100%, as shown in Table 9 of FIG. 9.

For each of the samples, the relative output deviation due to hydrogen was determined in the same manner as described in Experiment 1 with the endurance test time set to 200 hours. Then, the gas sensor element of the sample was evaluated, in terms of output deviation due to hydrogen, as being preferable when the determined relative output deviation due to hydrogen was lower than or equal to 10%, and as being not preferable otherwise.

As can be seen from Table 9, those gas sensor elements, in which the catalyst layer coverage was equal to 0 or 25%, was evaluated as being not preferable in terms of output deviation due to hydrogen. In contrast, those gas sensor elements, in which the catalyst layer coverage was greater than or equal to 30%, was evaluated as being preferable in terms of output deviation due to hydrogen.

Accordingly, it is made clear from the above that to effectively suppress the output deviation due to hydrogen of a gas sensor element, it is preferable to set the catalyst layer coverage in the gas sensor element to be greater than or equal to 30%.

What is claimed is:

1. A gas sensor element comprising:
a solid electrolyte body having oxygen ion conductivity and an opposite pair of first and second surfaces;
a measurement electrode provided on the first surface of the solid electrolyte body so as to be exposed to a measurement gas;
a reference electrode provided on the second surface of the solid electrolyte body so as to be exposed to a reference gas; and
a porous diffusion-resistant layer through which the measurement gas is introduced to the measurement electrode, the porous diffusion-resistant layer having an outer surface through which the measurement gas flows into the porous diffusion-resistant layer,
characterized in that
the gas sensor element further comprises a catalyst layer provided on the outer surface of the porous diffusion-resistant layer and a plurality of protective layers provided in layers on the catalyst layer,
the catalyst layer is comprised of a noble metal catalyst and catalyst-supporting particles that support the noble metal catalyst and has an average particle diameter,
each of the protective layers is comprised of oxide particles that have an average particle diameter,
the average particle diameter of the catalyst-supporting particles of the catalyst layer is less than or equal to the average particle diameter of the oxide particles of the one of the protective layers which adjoins the catalyst layer, and
the further the protective layers are from the catalyst layer, the larger the average particle diameters of the oxide particles of the protective layers are.

2. The gas sensor element as set forth in claim 1, wherein the noble metal catalyst of the catalyst layer is made of at least one of Pt, Pd, Rh, Ir, and Ru.

3. The gas sensor element as set forth in claim 1, wherein the catalyst-supporting particles of the catalyst layer are made of α-alumina, γ-alumina, or θ-alumina.

4. The gas sensor element as set forth in claim 3, wherein the catalyst-supporting particles of the catalyst layer are made of α-alumina.

5. The gas sensor element as set forth in claim 1, wherein the oxide particles of the outermost two of the protective layers are made of γ-alumina or θ-alumina.

6. The gas sensor element as set forth in claim 5, wherein each of the outermost two protective layers has a thickness greater than or equal to 6 μm.

7. The gas sensor element as set forth in claim 1, wherein, the average particle diameter of the catalyst-supporting particles of the catalyst layer is greater than 0.3 μm.

8. The gas sensor element as set forth in claim 1, wherein the average particle diameter of the oxide particles of the outermost one of the protective layers is less than or equal to 30 μm.

9. The gas sensor element as set forth in claim 1, wherein the catalyst layer has a thickness in the range of 2 to 20 μm.

10. The gas sensor element as set forth in claim 1, wherein the porous diffusion-resistant layer has a thickness in the range of 5 to 150 μm.

11. The gas sensor element as set forth in claim 1, wherein the catalyst layer has a greater porosity than the porous diffusion-resistant layer.

12. The gas sensor element as set forth in claim 1, wherein the porous diffusion-resistant layer has a porosity in the range of 30 to 60%.

13. The gas sensor element as set forth in claim 1, wherein the percentage of the outer surface of the porous diffusion-resistant layer being covered by the catalyst layer is higher than or equal to 30%.

14. A gas sensor characterized by comprising the gas sensor element as set forth in claim 1 to sense the concentration of a specific component in the measurement gas.

15. The gas sensor as set forth in claim 14, wherein the measurement gas is exhaust gas from a direct-injection engine, a turbocharged engine, or a CNG engine.

16. A method of manufacturing the gas sensor element as set forth in claim 1, characterized in that in forming the catalyst layer, a material for forming the catalyst layer is applied by printing.

17. The method as set forth in claim 16, wherein the printing, by which the material for forming the catalyst layer is applied, is pad printing, inkjet printing, or screen printing.

18. The method as set forth in claim 16, wherein the material for forming the catalyst layer has a viscosity higher than or equal to 1 Pa·s.

19. The method as set forth in claim 16, wherein in forming each of the protective layers, a material for forming the protective layer is applied by dipping.

20. The method as set forth in claim 19, wherein in forming each of the protective layers, the material for forming the protective layer has a viscosity lower than or equal to 1 Pa·s.
